(19) United States
(12) Patent Application Publication
(10) Pub. No.: US 2007/0107283 A1
(43) Pub. Date: May 17, 2007

(54) Outdoor signage with enhanced readability in direct sunlight

(76) Inventor: Hirofusa Otsubo, Middle Village, NY (US)

Correspondence Address: Hirofusa Otsubo, 60-16 83rd Place, Middle Village, NY, 11379, US

(21) Appl. No.: 11/283,114

(22) Filed: Nov. 17, 2005

(51) Int. Cl. G09F 7/00

(52) U.S. Cl. 40/584

(57) ABSTRACT

In a preferred embodiment of the present invention, the sign includes a plurality of spaced cutouts that either cut out at least a portion on or near the edge of at least one alphanumeric character or symbol in the indicia or are disposed within at least one alphanumeric character or symbol in the indicia, the cutouts being disposed with gaps therebetween and configured such that the corresponding at least one alphanumeric character or symbol is more legible when viewed in bright sunlight, esp. in situations of sun blindness.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates to traffic signs. More particularly, the invention relates to traffic signs with specially shaped, cut out holes, which reduce, if not prevent sun blindness.

### BACKGROUND OF THE INVENTION

Highway traffic signs become almost impossible to read when the sun goes behind them, especially during sunrise and sunset. This can cause drivers who are not familiar with the area to become confused and drive unpredictably, which affects the other cars around the driver. This tends to create unsafe driving conditions and sometimes accidents especially in the areas where highway traffic signs are positioned in between the Sun and the eyes of drivers during sun set and Sun rise hours.

In view of the foregoing, there is a need for an improved traffic sign, which reduce, if not prevents sun blindness by remaining visible when the sun is directly behind the sign, thus making it easier to read and less confusing for drivers.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary traffic sign letter in which striped shaped light holes (SLH) are cut from the center of the letter, in accordance with an embodiment of the present invention;

FIG. 2 illustrates an exemplary traffic sign letter in which SLH and round shaped light holes (RLH) are cut in the center of the letter, in accordance with an embodiment of the present invention;

FIG. 3 illustrates an exemplary traffic sign letter in which RLH are cut into the center of the letter, in accordance with an embodiment of the present invention;

FIG. 4 illustrates an exemplary traffic sign letter in which SLH are cut around the perimeter of the letter, in accordance with an embodiment of the present invention;

FIG. 5 illustrates an exemplary traffic sign letter in which SLH and RLH are cut around the perimeter of the letter, in accordance with an embodiment of the present invention; and

FIG. 6 illustrates an exemplary traffic sign letter in which RLH are cut around the perimeter of the letter, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, a variety of techniques are described for providing an outdoor sign with improved legibility in bright sunlight, esp. when bright enough to cause sun blindness, of indicia printed thereupon.

In a preferred embodiment of the present invention, the sign includes a plurality of spaced cutouts that either cut out a portion tracing the center of letter or around the perimeter of the letter or symbol in the indicia or are disposed within at least one alphanumeric character or symbol in the indicia, the cutouts being disposed with gaps therebetween and configured such that the corresponding at least one alphanumeric character or symbol is more legible when viewed in bright sunlight.

In other embodiments of the present invention, means and Steps for making an outdoor sign with improved legibility in bright sunlight, which includes means/steps for making at least one alphanumeric character or symbol in the indicia more legible when viewed in bright sunlight. Some embodiments further include means/steps for maintaining structural integrity of the sign under intended operating conditions. Yet other embodiments further comprises means/steps for collecting more light from light from the backside and funneling the increased collected light to the front side. Some alternate embodiments of the present invention included means/steps for reducing the overall force imparted to the sign by wind under wind conditions.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments.

Existing traffic signs block sunlight coming from behind, which often makes the sign unreadable when looked at from the front. This often causes the problem of sun blindness for a driver when the sun is positioned behind the sign. When this happens, the sign is unreadable until the driver comes to different angle against sunlight. One aspect of the present invention is to provide a traffic sign, which reduces, if not prevents, sun blindness, creating safer driving conditions because drivers will not be confused by unreadable signs.

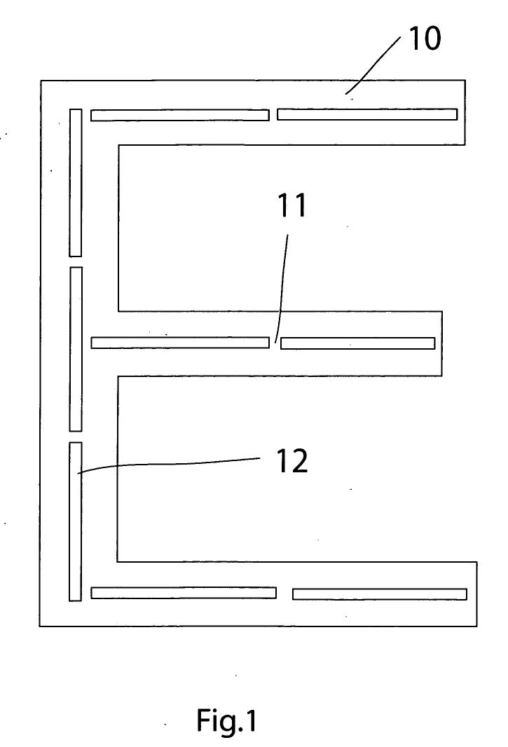

FIG. 1 illustrates an exemplary traffic sign letter in which striped shaped light holes (SLH) are cut from the center of the letter, in accordance with an embodiment of the present invention. In the present embodiment, a letter foundation 10 is painted in white reflective paint onto the main body of a traffic sign, which is usually painted green. However, those skilled in the art in light of the present teachings will recognize a multiplicity of alternative methods for lettering the sign used in combination with embodiments of the previous invention, such as, but not limited to, retroreflective material, transparent acrylic, self-illuminated, electronic diode illuminated and/or other lettering techniques that are used in traffic signs to improve legibility against sun blindness. In the present invention, striped shaped light holes (SLH) 12 are cut out of the center of letter foundation 10 following the shape of letter foundation 10. Enforcement connections 11 are intentionally left between SLH 12 to maintain the strength, rigidity, and structural integrity of the sign. SLH 12 allows sunlight to come through the sign in the shape of letter foundation 10. Drivers can now read the sign even when the sun is directly behind it. In some embodiments, reflective indicia may be placed in a line along SLH 12 or on both sides of SLH 12 as an addition on the white reflective paint of the main body of letter, thereby making the sign more visible at night when a car's headlights shine on it. The present embodiment of the invention requires no power or ongoing maintenance. Also, SLH 12 eases the wind force on the sign by allowing some air to pass through SLH 12 instead of being completely blocked by the sign.

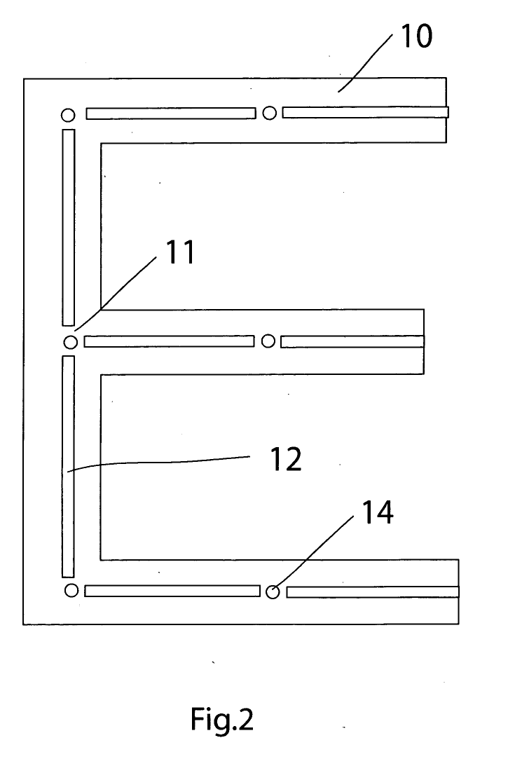

FIG. 2 illustrates an exemplary traffic sign letter in which SLH and round shaped light holes (RLH) are cut in the center of the letter, in accordance with an embodiment of the present invention. In the present embodiment, SLH 12 and round shaped light holes (RLH) 14 are cut into the center of letter foundation 10 in the shape of letter foundation 10. Enforcement connections 11 are left between SLH 12 and RLH 14 to maintain the strength, rigidity, and structural integrity of the sign.

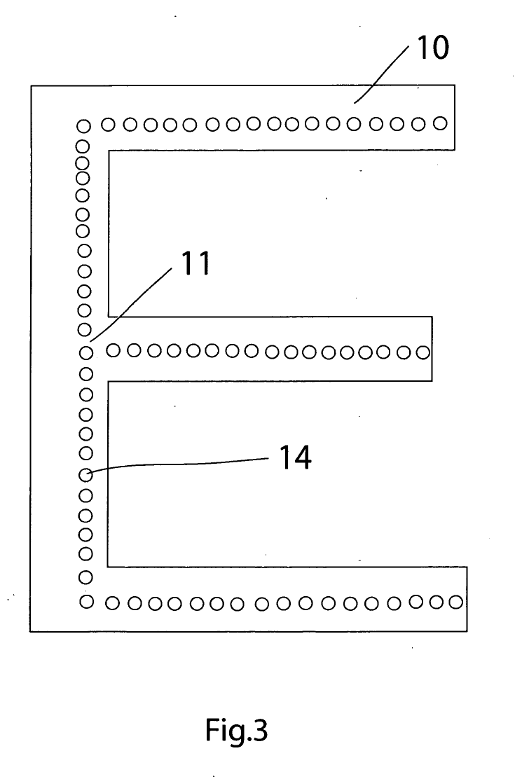

FIG. 3 illustrates an exemplary traffic sign letter in which RLH are cut into the center of the letter, in accordance with an embodiment of the present invention. In the present embodiment, RHL 14 are cut into the center of letter foundation 10 following the shape of letter foundation 10. Enforcement connections 11 are left between RHL 14 in order to maintain the strength, rigidity, and structural integrity of the sign.

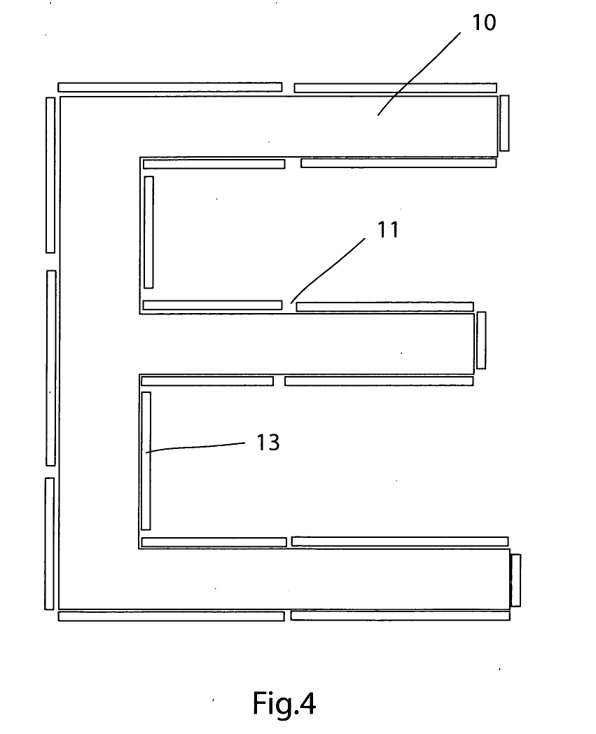

FIG. 4 illustrates an exemplary traffic sign letter in which SLH are cut around the perimeter of the letter, in accordance with an embodiment of the present invention. In the present embodiment, SLH 13 are cut along the outside edge of letter foundation 10. Enforcement connections 11 are intentionally left between SLH 13 in order to maintain the strength, rigidity, and structural integrity of the sign and to keep letter foundation 10 attached to the main body of the sign. SLH 13 allow light to come through the sign in the shape of letter foundation 10, which makes the sign more readable to a driver when the sun is directly behind the sign. In the present embodiment, letter foundation 10 is painted onto the main body of the sign with white reflective paint and may also have reflective indicia in the center of letter foundation 10 making it more visible to drivers at night when the cars' headlights shine on it.

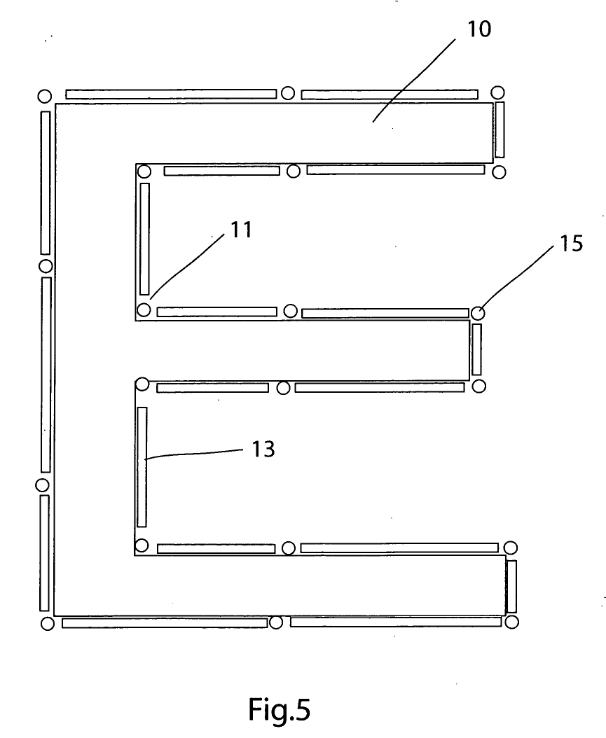

FIG. 5 illustrates an exemplary traffic sign letter in which SLH and RLH are cut around the perimeter of the letter, in accordance with an embodiment of the present invention. In the present embodiment, SLH 13 and RLH 15 are cut out of the sign around the outside of letter foundation 10. Enforcement connections 11 are left between SLH 13 and RLH 15 in order to maintain the strength, rigidity, and structural integrity of the sign, and so letter foundation 10 remains attached to the main body of the sign.

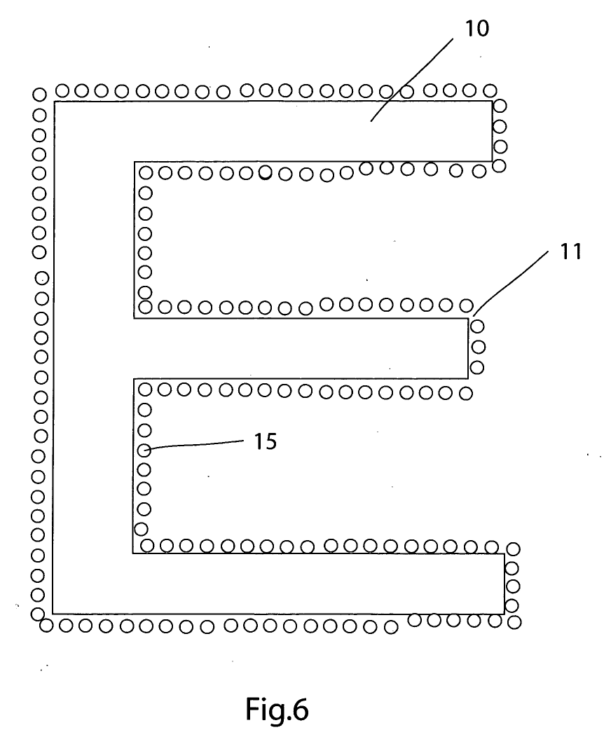

FIG. 6 illustrates an exemplary traffic sign letter in which RLH are cut around the perimeter of the letter, in accordance with an embodiment of the present invention. In the present embodiment, RLH 15 are cut out of the sign outlining letter foundation 10. Enforcement connections 11 are left between RLH 15 to maintain the strength and structural integrity of the sign and to keep letter foundation 10 attached to the main body of the sign.

In some embodiments of the present invention, the light holes can be cut wider in the back of the sign and narrower in the front in order to collect more light by way of a funneling-like effect.

In alternate embodiments, instead of cutting holes in or around the letters of the sign, the entire letter can be cut clean out of the sign.

In some embodiments, the light holes can be filled with a transparent colored material, such as, but not limited to glass, to create a stained glass effect, which has the benefit of creating distinguishing colors without requiring powered lighting sources as required in conventional approaches.

Those skilled in the art, in light of the teachings of the present invention, will readily recognize a multiplicity of alternate and suitable cutout patterns to form or outline letters or symbols used to communicate information in outdoor signage. For example, without limitation, any combination of the patterns shown may be mixed or matched in some embodiments and any suitable cutout shape or orientation may be implemented depending upon the needs of the particular application.

Having fully described at least one embodiment of the present invention, other equivalent or alternative methods of implementing a sign reducing sun blindness according to the present invention will be apparent to those skilled in the art. The invention has been described above by way of example, and the specific embodiments disclosed are not intended to limit the invention to the particular forms disclosed. Although the examples described above were described in the context of highway traffic signs, it is contemplated the teachings of the present invention may also be readily adaptable to any kind of out door signage, which are also contemplated as being within the scope of the present invention. The invention is thus to cover all modifications, equivalents, and alternatives falling within the spirit and scope of the following claims.

What is claimed is:

1. An outdoor sign with improved legibility in bright sunlight of indicia printed thereupon, the sign comprising:
a plurality of spaced cutouts that either cut out at least a portion on or near the edge of at least one alphanumeric character or symbol in the indicia or are disposed within at least one alphanumeric character or symbol in the indicia, said cutouts being disposed with gaps therebetween and configured such that the corresponding at least one alphanumeric character or symbol is more legible when viewed in bright sunlight.

2. The outdoor sign of claim 1, wherein at least a portion of said cutouts are disposed just outside and along an edge of at least one alphanumeric character or symbol in the indicia.

3. The outdoor sign of claim 1, wherein at least a portion of said cutouts are disposed upon an edge of at least one alphanumeric character or symbol in the indicia.

4. The outdoor sign of claim 1, wherein at least a portion of said gaps are minimal sized between adjacent cutouts to maintain structural integrity of said sign under intended operating conditions.

5. The outdoor sign of claim 1, wherein at least a portion of said cutouts have and alternating pattern of adjacent cutout shapes to maintain structural integrity of said sign under intended operating conditions.

6. The outdoor sign of claim 1, wherein said sign is not electrically powered to make it more legible when viewed in bright sunlight.

7. The outdoor sign of claim 1, wherein at least a portion of said cutouts are disposed midway between opposing edges of at least one alphanumeric character or symbol in the indicia, thereby forming a central lined representation of the corresponding alphanumeric character(s) or symbol(s) in the indicia.

8. The outdoor sign of claim 1, wherein at least a portion of said cutouts are configured to be shaped as a cutout circle, elongated rectangle, or other geometric shape.

9. The outdoor sign of claim 1, wherein at least a portion of said cutouts are configured to be sized large enough to allow enough sunlight to pass through them to provide adequate visual distinction between the cutout regions and the non-cutout regions to thereby improve the legibility of the corresponding alphanumeric character(s) or symbol(s) in the indicia.

10. The outdoor sign of claim 1, wherein at least a portion of said cutouts are configured to be sized wider in the back of said sign than the corresponding locations on the front of said sign, the size difference being suitable for collecting more light from light from the backside and funneling the increased collected light to the front side.

11. The outdoor sign of claim 1, wherein at least a portion of said cutouts are configured to be filled with a translucent material that alters sunlight to provide adequate visual distinction between the filled cutout regions and the non-cutout regions to thereby improve the legibility of the corresponding alphanumeric character(s) or symbol(s) in the indicia.

12. The outdoor sign of claim 1, wherein said sign requires no ongoing maintenance to make it more legible when viewed in bright sunlight.

13. The outdoor sign of claim 1, wherein at least a portion of said cutouts are configured to allow wind to pass through them under windy conditions to reduce the overall force imparted to said sign by wind.

14. An outdoor sign with improved legibility in bright sunlight, the sign comprising:
indicia printed upon said sign, the indicia having at least one alphanumeric character or symbol; and
means for making at least one alphanumeric character or symbol in said indicia more legible when viewed in bright sunlight.

15. The outdoor sign of claim 14, in which said means for improved indicia legibility further comprises means for maintaining structural integrity of said sign under intended operating conditions.

16. The outdoor sign of claim 14, in which said means for improved indicia legibility further comprises means for collecting more light from light from the backside and funneling the increased collected light to the front side.

17. The outdoor sign of claim 14, in which said means for improved indicia legibility further comprises means for reducing the overall force imparted to said sign by wind under windy conditions.

18. A method for making an outdoor sign with improved legibility in bright sunlight of indicia printed thereupon, the method comprising:
steps for making at least one alphanumeric character or symbol in said indicia more legible when viewed in bright sunlight.

19. The method of claim 18, further comprising Steps for maintaining structural integrity of said sign under intended operating conditions.

20. The method of claim 18, further comprising Steps for noticeably reducing the overall force imparted to said sign by wind under windy conditions.
